(19) United States
(12) Patent Application Publication
(10) Pub. No.: US 2023/0102271 A1
(43) Pub. Date: Mar. 30, 2023

(54) DETECTION AND MITIGATION OF DOMAIN-BASED ANOMALIES

(71) Applicant: Cisco Technology, Inc., San Jose, CA (US)

(72) Inventors: Robert Warren Webb, Stuart, FL (US); Bernard Wayne CLAIRMONT, Portland, OR (US); Kyle Andrew Donald MESTERY, Woodbury, MN (US)

(21) Appl. No.: 17/484,999

(22) Filed: Sep. 24, 2021

(51) Int. Cl. H04L 29/06

(52) U.S. Cl. CPC H04L 63/1425; H04L 63/1441

(57) ABSTRACT

In one embodiment, a device receives results of a plurality of load tests for a web application, the results comprising information about one or more domains accessed when loading the web application during the plurality of load tests. The device determines a baseline of expected domains that are accessed during loading of the web application based on normalizing the results of the plurality of load tests. The device identifies, based on the baseline of expected domains, an anomalous domain that is loaded during a loading of the web application. The device performs one or more mitigation actions in response to identifying the anomalous domain.

### TECHNICAL FIELD

The present disclosure relates generally to computer systems, and, more particularly, to detection and mitigation of domain-based anomalies.

### BACKGROUND

The Internet and the World Wide Web have enabled the proliferation of web services available for virtually all types of businesses. Due to the accompanying complexity of the infrastructure supporting the web services, it is becoming increasingly difficult to maintain the highest level of service performance and user experience to keep up with the increase in web services. For example, it can be challenging to piece together monitoring and logging data across disparate systems, tools, and layers in a network architecture. Moreover, even when data can be obtained, it is difficult to directly connect the chain of events and cause and effect.

The proliferation of web services has given many ill-willed individuals and organizations a plethora of opportunities to perform malicious acts. For example, when a web application (or webpage) is being hacked, users attempting to access the web application at their devices (e.g., by entering a URL of the web application at a web browser) may have their devices unsuspectingly load unscrupulous domains and/or data as part of their device's loading of the web application. This may result in compromised data, phishing schemes, malware, ransomware, etc. The ability to detect and mitigate these unintended domains, particularly at scale, has been a difficult task. Notably, these types of attacks usually go unnoticed until the attack is well underway in part due to voluminous nature of the aforementioned monitoring and logging data that may be collected.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example observability intelligence platform;

FIG. 4 illustrates an example architecture for detection and mitigation of domain-based anomalies;

FIG. 5 illustrates example test results of a load test performed by an agent;

FIGS. 6A-6B illustrate an example comparison of a normalized loading of a web application with a subsequent loading of the web application;

FIG. 7 illustrates an example anomaly detection notification;

FIG. 8 illustrates example page load test results indicative of whether expected changes for web application have occurred;

FIG. 9 illustrates an example architecture for cross-application page load test monitoring; and

FIG. 10 illustrates an example simplified procedure for detection and mitigation of domain-based anomalies in accordance with one or more embodiments described herein.

### DESCRIPTION OF EXAMPLE EMBODIMENTS

### Overview

According to one or more embodiments of the disclosure, a device receives results of a plurality of load tests for a web application, the results comprising information about one or more domains accessed when loading the web application during the plurality of load tests. The device determines a baseline of expected domains that are accessed during loading of the web application based on normalizing the results of the plurality of load tests. The device identifies, based on the baseline of expected domains, an anomalous domain that is loaded during a loading of the web application. The device performs one or more mitigation actions in response to identifying the anomalous domain.

Other embodiments are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

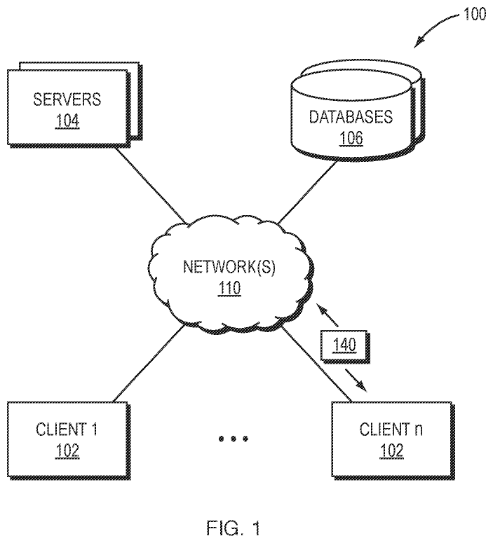

FIG. 1 is a schematic block diagram of an example simplified computing system 100 illustratively comprising any number of client devices 102 (e.g., a first through nth client device), one or more servers 104, and one or more databases 106, where the devices may be in communication with one another via any number of networks 110. The one or more networks 110 may include, as would be appreciated, any number of specialized networking devices such as routers, switches, access points, etc., interconnected via wired and/or wireless connections. For example, devices 102-104 and/or the intermediary devices in network(s) 110 may communicate wirelessly via links based on Wi-Fi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some embodiments, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

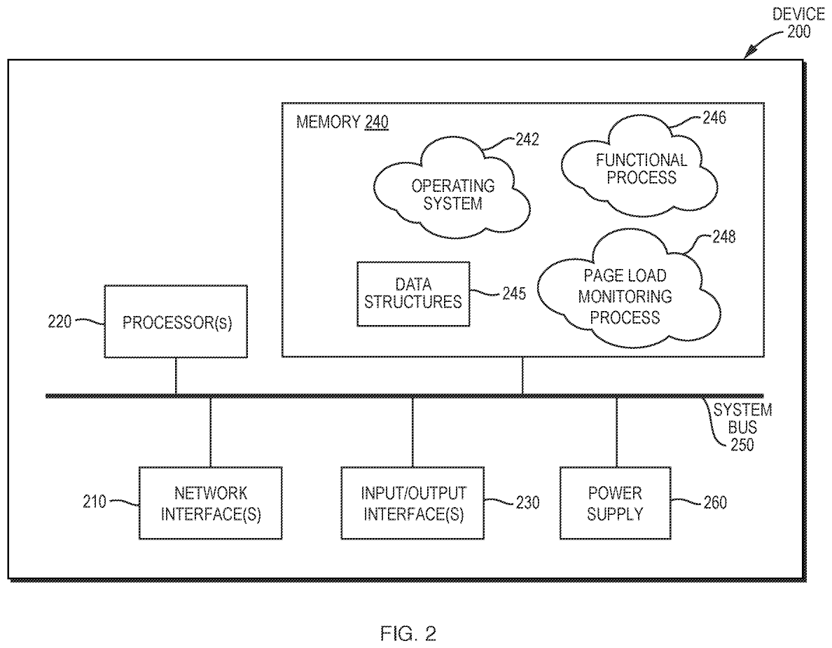

FIG. 2 is a schematic block diagram of an example node/device 200 that may be used with one or more embodiments described herein, e.g., as any of the devices 102-106 shown in FIG. 1 above. Device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the network interfaces 210 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise a one or more functional processes 246, and on certain devices, an illustrative page load monitoring process 248, as described herein. Notably, functional processes 246, when executed by processor(s) 220, cause each particular device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

—Observability Intelligence Platform—

As noted above, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a software as a service (SaaS) over a network, such as the Internet. As an example, a distributed application can be implemented as a SaaS-based web service available via a web site that can be accessed via the Internet. As another example, a distributed application can be implemented using a cloud provider to deliver a cloud-based service.

Users typically access cloud-based/web-based services (e.g., distributed applications accessible via the Internet) through a web browser, a light-weight desktop, and/or a mobile application (e.g., mobile app) while the enterprise software and user's data are typically stored on servers at a remote location. For example, using cloud-based/web-based services can allow enterprises to get their applications up and running faster, with improved manageability and less maintenance, and can enable enterprise IT to more rapidly adjust resources to meet fluctuating and unpredictable business demand. Thus, using cloud-based/web-based services can allow a business to reduce Information Technology (IT) operational costs by outsourcing hardware and software maintenance and support to the cloud provider.

However, a significant drawback of cloud-based/web-based services (e.g., distributed applications and SaaS-based solutions available as web services via web sites and/or using other cloud-based implementations of distributed applications) is that troubleshooting performance problems can be very challenging and time consuming. For example, determining whether performance problems are the result of the cloud-based/web-based service provider, the customer's own internal IT network (e.g., the customer's enterprise IT network), a user's client device, and/or intermediate network providers between the user's client device/internal IT network and the cloud-based/web-based service provider of a distributed application and/or web site (e.g., in the Internet) can present significant technical challenges for detection of such networking related performance problems and determining the locations and/or root causes of such networking related performance problems. Additionally, determining whether performance problems are caused by the network or an application itself, or portions of an application, or particular services associated with an application, and so on, further complicate the troubleshooting efforts.

Certain aspects of one or more embodiments herein may thus be based on (or otherwise relate to or utilize) an observability intelligence platform for network and/or application performance management. For instance, solutions are available that allow customers to monitor networks and applications, whether the customers control such networks and applications, or merely use them, where visibility into such resources may generally be based on a suite of “agents” or pieces of software that are installed in different locations in different networks (e.g., around the world).

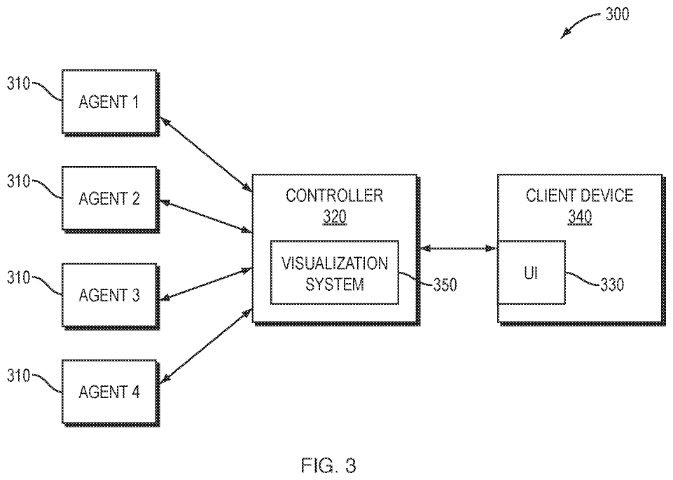

Specifically, as discussed with respect to illustrative FIG. 3 below, performance within any networking environment may be monitored, specifically by monitoring applications and entities (e.g., transactions, tiers, nodes, and machines) in the networking environment using agents installed at individual machines at the entities. As an example, applications may be configured to run on one or more machines (e.g., a customer will typically run one or more nodes on a machine, where an application consists of one or more tiers, and a tier consists of one or more nodes). The agents collect data associated with the applications of interest and associated nodes and machines where the applications are being operated. Examples of the collected data may include performance data (e.g., metrics, metadata, etc.) and topology data (e.g., indicating relationship information), among other configured information. The agent-collected data may then be provided to one or more servers or controllers to analyze the data.

Examples of different agents (in terms of location) may comprise cloud agents (e.g., deployed and maintained by the observability intelligence platform provider), enterprise agents (e.g., installed and operated in a customer's network), and endpoint agents, which may be a different version of the previous agents that is installed on actual users' (e.g., employees') devices (e.g., on their web browsers or otherwise). Other agents may specifically be based on categorical configurations of different agent operations, such as language agents (e.g., Java agents, .Net agents, PHP agents, and others), machine agents (e.g., infrastructure agents residing on the host and collecting information regarding the machine which implements the host such as processor usage, memory usage, and other hardware information), and network agents (e.g., to capture network information, such as data collected from a socket, etc.).

Each of the agents may then instrument (e.g., passively monitor activities) and/or run tests (e.g., actively create events to monitor) from their respective devices, allowing a customer to customize from a suite of tests against different networks and applications or any resource that they're interested in having visibility into, whether it's visibility into that end point resource or anything in between, e.g., how a device is specifically connected through a network to an end resource (e.g., full visibility at various layers), how a website is loading, how an application is performing, how a particular business transaction (or a particular type of business transaction) is being effected, and so on, whether for individual devices, a category of devices (e.g., type, location, capabilities, etc.), or any other suitable embodiment of categorical classification.

FIG. 3 is a block diagram of an example observability intelligence platform 300 that can implement one or more aspects of the techniques herein. The observability intelligence platform is a system that monitors and collects metrics of performance data for a network and/or application environment being monitored. At the simplest structure, the observability intelligence platform includes one or more agents 310 and one or more servers/controllers 320. Agents may be installed on network browsers, devices, servers, etc., and may be executed to monitor the associated device and/or application, the operating system of a client, and any other application, API, or another component of the associated device and/or application, and to communicate with (e.g., report data and/or metrics to) the controller(s) 320 as directed. Note that while FIG. 3 shows four agents (e.g., Agent 1 through Agent 4) communicatively linked to a single controller, the total number of agents and controllers can vary based on a number of factors including the number of networks and/or applications monitored, how distributed the network and/or application environment is, the level of monitoring desired, the type of monitoring desired, the level of user experience desired, and so on.

For example, instrumenting an application with agents may allow a controller to monitor performance of the application to determine such things as device metrics (e.g., type, configuration, resource utilization, etc.), network browser navigation timing metrics, browser cookies, application calls and associated pathways and delays, other aspects of code execution, etc. Moreover, if a customer uses agents to run tests, probe packets may be configured to be sent from agents to travel through the Internet, go through many different networks, and so on, such that the monitoring solution gathers all of the associated data (e.g., from returned packets, responses, and so on, or, particularly, a lack thereof). Illustratively, different “active” tests may comprise HTTP tests (e.g., using curl to connect to a server and load the main document served at the target), Page Load tests (e.g., using a browser to load a full page—i.e., the main document along with all other components that are included in the page), or Transaction tests (e.g., same as a Page Load, but also performing multiple tasks/steps within the page—e.g., load a shopping website, log in, search for an item, add it to the shopping cart, etc.).

The controller 320 is the central processing and administration server for the observability intelligence platform. The controller 320 may serve a browser-based user interface (UI) 330 that is the primary interface for monitoring, analyzing, and troubleshooting the monitored environment. Specifically, the controller 320 can receive data from agents 310 (and/or other coordinator devices), associate portions of data (e.g., topology, business transaction end-to-end paths and/or metrics, etc.), communicate with agents to configure collection of the data (e.g., the instrumentation/tests to execute), and provide performance data and reporting through the interface 330. The interface 330 may be viewed as a web-based interface viewable by a client device 340. In some implementations, a client device 340 can directly communicate with controller 320 to view an interface for monitoring data. The controller 320 can include a visualization system 350 for displaying the reports and dashboards related to the disclosed technology. In some implementations, the visualization system 350 can be implemented in a separate machine (e.g., a server) different from the one hosting the controller 320.

Notably, in an illustrative Software as a Service (SaaS) implementation, a controller instance 320 may be hosted remotely by a provider of the observability intelligence platform 300. In an illustrative on-premises (On-Prem) implementation, a controller instance 320 may be installed locally and self-administered.

The controllers 320 receive data from different agents 310 (e.g., Agents 1-4) deployed to monitor networks, applications, databases and database servers, servers, and end user clients for the monitored environment. Any of the agents 310 can be implemented as different types of agents with specific monitoring duties. For example, application agents may be installed on each server that hosts applications to be monitored. Instrumenting an agent adds an application agent into the runtime process of the application.

Database agents, for example, may be software (e.g., a Java program) installed on a machine that has network access to the monitored databases and the controller. Standalone machine agents, on the other hand, may be standalone programs (e.g., standalone Java programs) that collect hardware-related performance statistics from the servers (or other suitable devices) in the monitored environment. The standalone machine agents can be deployed on machines that host application servers, database servers, messaging servers, Web servers, etc. Furthermore, end user monitoring (EUM) may be performed using browser agents and mobile agents to provide performance information from the point of view of the client, such as a web browser or a mobile native application. Through EUM, web use, mobile use, or combinations thereof (e.g., by real users or synthetic agents) can be monitored based on the monitoring needs.

Note that monitoring through browser agents and mobile agents are generally unlike monitoring through application agents, database agents, and standalone machine agents that are on the server. In particular, browser agents may generally be embodied as small files using web-based technologies, such as JavaScript agents injected into each instrumented web page (e.g., as close to the top as possible) as the web page is served, and are configured to collect data. Once the web page has completed loading, the collected data may be bundled into a beacon and sent to an EUM process/cloud for processing and made ready for retrieval by the controller. Browser real user monitoring (Browser RUM) provides insights into the performance of a web application from the point of view of a real or synthetic end user. For example, Browser RUM can determine how specific Ajax or iframe calls are slowing down page load time and how server performance impact end user experience in aggregate or in individual cases. A mobile agent, on the other hand, may be a small piece of highly performant code that gets added to the source of the mobile application. Mobile RUM provides information on the native mobile application (e.g., iOS or Android applications) as the end users actually use the mobile application. Mobile RUM provides visibility into the functioning of the mobile application itself and the mobile application's interaction with the network used and any server-side applications with which the mobile application communicates.

Note further that in certain embodiments, in the application intelligence model, a business transaction represents a particular service provided by the monitored environment. For example, in an e-commerce application, particular real-world services can include a user logging in, searching for items, or adding items to the cart. In a content portal, particular real-world services can include user requests for content such as sports, business, or entertainment news. In a stock trading application, particular real-world services can include operations such as receiving a stock quote, buying, or selling stocks.

A business transaction, in particular, is a representation of the particular service provided by the monitored environment that provides a view on performance data in the context of the various tiers that participate in processing a particular request. That is, a business transaction, which may be identified by a unique business transaction identification (ID), represents the end-to-end processing path used to fulfill a service request in the monitored environment (e.g., adding items to a shopping cart, storing information in a database, purchasing an item online, etc.). Thus, a business transaction is a type of user-initiated action in the monitored environment defined by an entry point and a processing path across application servers, databases, and potentially many other infrastructure components. Each instance of a business transaction is an execution of that transaction in response to a particular user request (e.g., a socket call, illustratively associated with the TCP layer). A business transaction can be created by detecting incoming requests at an entry point and tracking the activity associated with request at the originating tier and across distributed components in the application environment (e.g., associating the business transaction with a 4-tuple of a source IP address, source port, destination IP address, and destination port). A flow map can be generated for a business transaction that shows the touch points for the business transaction in the application environment. In one embodiment, a specific tag may be added to packets by application specific agents for identifying business transactions (e.g., a custom header field attached to a hypertext transfer protocol (HTTP) payload by an application agent, or by a network agent when an application makes a remote socket call), such that packets can be examined by network agents to identify the business transaction identifier (ID) (e.g., a Globally Unique Identifier (GUID) or Universally Unique Identifier (UUID)). Performance monitoring can be oriented by business transaction to focus on the performance of the services in the application environment from the perspective of end users. Performance monitoring based on business transactions can provide information on whether a service is available (e.g., users can log in, check out, or view their data), response times for users, and the cause of problems when the problems occur.

In accordance with certain embodiments, the observability intelligence platform may use both self-learned baselines and configurable thresholds to help identify network and/or application issues. A complex distributed application, for example, has a large number of performance metrics and each metric is important in one or more contexts. In such environments, it is difficult to determine the values or ranges that are normal for a particular metric; set meaningful thresholds on which to base and receive relevant alerts; and determine what is a “normal” metric when the application or infrastructure undergoes change. For these reasons, the disclosed observability intelligence platform can perform anomaly detection based on dynamic baselines or thresholds, such as through various machine learning techniques, as may be appreciated by those skilled in the art. For example, the illustrative observability intelligence platform herein may automatically calculate dynamic baselines for the monitored metrics, defining what is “normal” for each metric based on actual usage. The observability intelligence platform may then use these baselines to identify subsequent metrics whose values fall out of this normal range.

In general, data/metrics collected relate to the topology and/or overall performance of the network and/or application (or business transaction) or associated infrastructure, such as, e.g., load, average response time, error rate, percentage CPU busy, percentage of memory used, etc. The controller UI can thus be used to view all of the data/metrics that the agents report to the controller, as topologies, heatmaps, graphs, lists, and so on. Illustratively, data/metrics can be accessed programmatically using a Representational State Transfer (REST) API (e.g., that returns either the JavaScript Object Notation (JSON) or the eXtensible Markup Language (XML) format). Also, the REST API can be used to query and manipulate the overall observability environment.

Those skilled in the art will appreciate that other configurations of observability intelligence may be used in accordance with certain aspects of the techniques herein, and that other types of agents, instrumentations, tests, controllers, and so on may be used to collect data and/or metrics of the network(s) and/or application(s) herein. Also, while the description illustrates certain configurations, communication links, network devices, and so on, it is expressly contemplated that various processes may be embodied across multiple devices, on different devices, utilizing additional devices, and so on, and the views shown herein are merely simplified examples that are not meant to be limiting to the scope of the present disclosure.

—Detection and Mitigation of Domain-Based Anomalies—

As noted above, the proliferation of web services has given many ill-willed individuals and organizations a plethora of opportunities to perform malicious acts. For example, when a web application (or webpage) is being hacked, users attempting to access the web application at their devices (e.g., by entering a URL of the web application at a web browser) may have their devices unsuspectingly load unscrupulous domains and/or data as part of their device's loading of the web application. This may result in compromised data, phishing schemes, malware, ransomware, etc. The ability to detect and mitigate these unintended domains, particularly at scale, has been a difficult task. Notably, these types of attacks usually go unnoticed until the attack is well underway in part due to voluminous nature of the aforementioned monitoring and logging data that may be collected.

The techniques herein, therefore, leverage various types of agents and their ability to perform tests, particularly, tests that identify one or more domains that are accessed by agents (e.g., a Page Load test or a Transaction test) while loading a web application (e.g., a webpage or other online application). The results of these tests may be aggregated over time, then the aggregated test results may be analyzed to identify domains (or associated data) as anomalous (as compared to previously gathered results). Such analysis may include, for example, normalizing the aggregated test results to determine a baseline of “expected” domains that are included in loadings of a web application, then comparing subsequent loadings of the web application to the baseline. For example, new domains or providers (e.g., server networks) that are loaded by an end-user device or agent may be identified as anomalous if they have had not been previously loaded in the last 30 days of normalized, aggregated test results (when accessing a particular web application).

Additionally, because test results may be gathered for visits to a plurality of web applications, analyses may be performed to determine whether new domains or servers have appeared across the page loads of a group of web applications. Further, the agents may be configured to compare results of tests, which indicate the domains visited in a page load of a web application, to a list of known or suspected malicious domains, and if there is a match, a particular domain may be identified as anomalous. In another embodiment, the results of the tests may be compared to an expected list of domains (e.g., in a scenario where a web application owner has made changes to the web application and is testing whether its changes have been properly implemented), and if there is not a match (i.e., a domain should have been included in a loading of a web application), a missing domain may be identified as anomalous.

In these examples, a warning, alarm, notification, etc. may be sent to operators of the web applications and/or owners of an end-user device that have the visited the web applications (e.g., that have one of the agents installed) when a domain has been identified as anomalous. It is contemplated that the analysis of aggregated test results (that include domains visited in loadings of a web application) may, along with normalization techniques, implement various machine learning techniques described herein below. Further, such machine learning techniques may be used to calculate risks associated with identified anomalous domains and/or data, where these domains may be ranked and/or be associated with different tiers of warnings, alarms, etc., for example, when sent to an end-user.

Specifically, according to one or more embodiments described herein, a device receives results of a plurality of load tests for a web application, the results comprising information about one or more domains accessed when loading the web application during the plurality of load tests. The device determines a baseline of expected domains that are accessed during loading of the web application based on normalizing the results of the plurality of load tests. The device identifies, based on the baseline of expected domains, an anomalous domain and/or data that is loaded during a loading of the web application. The device performs one or more mitigation actions in response to identifying the anomalous domain.

Notably, as previously mentioned, the techniques herein may employ any number of machine learning techniques, such as to classify the collected data (e.g., test results of Page Load tests and/or Transaction tests) and to cluster the data as described herein. In general, machine learning is concerned with the design and the development of techniques that receive empirical data as input (e.g., collected metric/event data from agents, sensors, etc.) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a, b, c such that the number of misclassified points is minimal. After this optimization/learning phase, the techniques herein can use the model M to classify new data points. Often, M is a statistical model, and the cost function is inversely proportional to the likelihood of M, given the input data.

One class of machine learning techniques that is of particular use herein is clustering. Generally speaking, clustering is a family of techniques that seek to group data according to some typically predefined or otherwise determined notion of similarity.

Also, the performance of a machine learning model can be evaluated in a number of ways based on the number of true positives, false positives, true negatives, and/or false negatives of the model.

In various embodiments, such techniques may employ one or more supervised, unsupervised, or semi-supervised machine learning models. Generally, supervised learning entails the use of a training set of data, as noted above, that is used to train the model to apply labels to the input data. On the other end of the spectrum are unsupervised techniques that do not require a training set of labels. Notably, while a supervised learning model may look for previously seen patterns that have been labeled as such, an unsupervised model may attempt to analyze the data without applying a label to it. Semi-supervised learning models take a middle ground approach that uses a greatly reduced set of labeled training data.

Example machine learning techniques that the techniques herein can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) artificial neural networks (ANNs) (e.g., for non-linear models), replicating reservoir networks (e.g., for non-linear models, typically for time series), random forest classification, or the like.

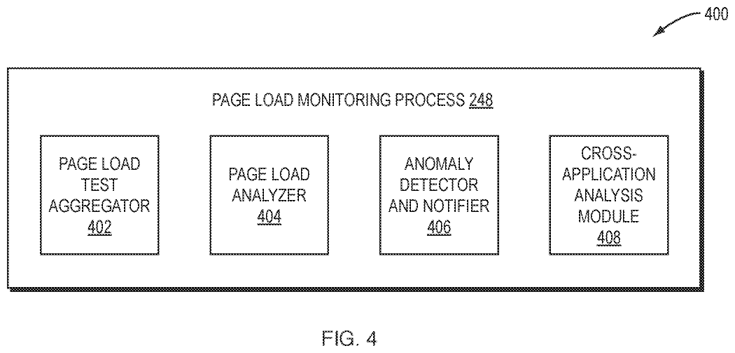

Operationally, FIG. 4 illustrates an example architecture 400 for a page load monitoring service, according to various embodiments. At the core of architecture 400 is page load monitoring process 248, which may be executed by a device that provides a page load monitoring service in a network, or another device in communication therewith. As shown, page load monitoring process 248 may include any or all of the following components: a page load test aggregator 402, a page load analyzer 404, an anomaly detector and notifier 406, and/or cross-application analysis module 408. As would be appreciated, the functionalities of these components may be combined or omitted, as desired. In addition, these components may be implemented on a singular device, for example, controller 320, or in a distributed manner, in which case the combination of executing devices can be viewed as their own singular device for purposes of executing page load monitoring process 248.

During execution, page load test aggregator 402 may operate to aggregate test results from a plurality of agents, for example, agents 310 described with respect to FIG. 3. As described herein above, such agents may be configured to perform a Page Load test that causes the agents to gather data or information indicative of one or more domains that are included in a particular loading of a web application (e.g., a webpage). Additionally, the agents may perform multi-step transaction tests (e.g., a Transaction test), which, when performed, gathers similar information as that gathered from Page Load tests but from a different perspective (i.e., based on a transaction within a webpage, rather than merely the loading of a webpage). The tests performed by the agents may be performed by different types of agents that are geographically located all over the world as well as being located at different parts of internet infrastructure. For example, the agents may include endpoint agents, cloud agents, enterprise agents, etc., all of which are described in greater detail above. Page load test aggregator 402 may be configured to aggregate the test results from a plurality of agents, where the tests are directed to a plurality of web applications or webpages. Page load test aggregator 402 may also be configured to store the test results over a period of a time and to make the test results available to other components of page load monitoring process 248.

Page load analyzer 404 is primarily responsible for analyzing the tests results aggregated by page load test aggregator 402 by determining a baseline of expected domains that are accessed during loading of the web application. For example, page load analyzer 404 may be configured to identify test results for a page loads of visits by agents to a particular webpage over a particular number of days (e.g., 30 days) or any time period and to normalize these identified test results. Normalization of these test results leads to a list of domains and/or service providers (e.g., particular websites, objects of domains, applications, services, etc.) that can be understood as “expected” to be seen during a normal loading of a web application.

It is contemplated that machine learning techniques may be used by page load test aggregator 402 to implement the normalization (or even standardization) of the test results. In other words, the machine learning techniques may generate a model of expected domains that are loaded during visits of a particular web application, where the model may be used, by for example an anomaly detector and notifier 406, to compare subsequent loads of the web application to determine whether future loads include any anomalous domains and/or data.

Anomaly detector and notifier 406, after the page load analyzer 404 has determined a baseline of expected domains for a particular web application, is configured to determine whether a subsequent visit to the web application by an agent, located at an end-user device, in the cloud, etc. includes an anomalous domain. The anomalous domain (and/or data) may be understood as anything new or extraneous than what is expected in the baseline, for example, a new domain, a new host, a new provider, etc. It is contemplated, however, that in certain embodiments, anomaly detector and notifier 406 may be configured to determine whether a domain (or another web resource loaded when visiting a web application) is missing from the baseline.

Anomaly detector and notifier 406 may also be configured to determine a level of threat of domains that it has identified as anomalous as well as take appropriate remediation and/or mitigation action. For example, anomaly detector and notifier 406 may be configured to only identify a new domain, host, etc. anomalous domains based on a domain level (e.g., sub-domain status). Notably, changes at lower levels (e.g., third level sub-domains or lower) may be understood as frequently occurring, and may not warrant being flagged as anomalous, while changes at higher levels (e.g., a second level of a domain) may be monitored or indicative of malicious and/suspicious activity.

In an embodiment, anomaly detector and notifier 406 may be configured to react to and/or mitigate any anomalous domains (and/or data), such as to automatically flag and report anomalous domains via a notification (e.g., an alert) to operators of web applications or end-user devices that have visited a particular web application. In an embodiment, anomaly detector and notifier 406 may be configured to automatically block, remove, or revert, anomalous domains and associated data from a loading of a web application. In another embodiment, anomaly detector and notifier 406 may be configured to feed identified anomalous domains into firewalls of associated devices (e.g., in networks and/or sub-networks where agents 310 are installed), where doing so results in termination of active TLS connections with the anomalous domains (and/or data). Further, anomaly detector and notifier 406 may be configured to compare an identified new domain, host, etc. to a list of known or suspected malicious domains, and if there is a match, a particular domain may be identified as anomalous. In another embodiment, the results of the tests may be compared to an expected list of domains (e.g., in the scenario where a web application owner has made changes to the web application and is testing whether its changes have been properly implemented), and if there is not a match (i.e., a domain should have been included in a loading of a web application), a missing domain may be identified as anomalous.

Anomaly detector and notifier 406 may also be configured to generate a variety of graphical user interface-based (GUI-based) images and/or maps that indicate locations of anomalous domains. For example, geographic locations may be correlated with anomalous domains and may be displayed in a heat map (e.g., a global view) that indicates physical locations of the anomalous domains. Additional information that may be displayed in the heat map included a number of anomalous domains, where an excess amount, as understood in the art, may indicate an internet-based attack.

According to one or particular embodiments herein, cross-application analysis module 408 may be configured to analyze loadings of more than one web application (or webpage), for example, for groupings of web applications that share a common industrial purpose, common end-users/customers, etc. For example, test results may be gathered by agents for loadings of a plurality of banking web applications, mail servers, sales platforms, etc. In addition to normalizing test results on a single web application basis, cross-application analysis module 408 may be configured to normalize test results across categories or fields of web applications. This expanded view of the test results may present even more interesting detection capabilities and analysis that may be performed by page load monitoring process 248. For example, assume that a first customer (e.g., a bank) starts seeing a new domain appear in their page load, followed by a second customer (e.g., another bank) beginning to see the same domain appear shortly afterward, followed by a third customer, etc. This data provides greater insight (and suspicion) than merely seeing an anomalous domain (and/or data) at a single application/customer. Also, by normalizing against multiple customers, known “safe” domains at one customer that newly appear at another may be assessed appropriately as safe, knowing that other customers are already including that service/domain within their loadings of the web application (e.g., a new application organically propagating its way through multiple competitors).

According to one or particular embodiments herein, cross-application analysis module 408 may be further configured to modify or even remove groupings (or categories) of web applications in its analysis. Such removal would lead to analysis of anomalous domains and/or data across all web-applications and agents collecting data. It is contemplated that, as this could be a very intensive data analysis process, it may be best performed by only comparing domains and provider networks that have already been flagged as anomalous (within a single web-application), thereby greatly reducing potential required computing resources.

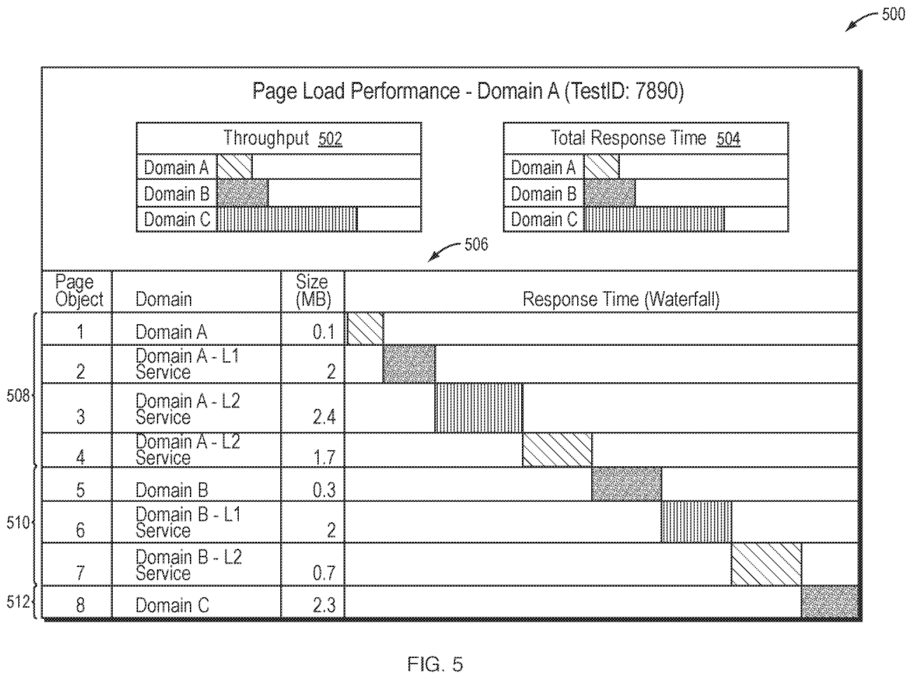

Turning now to FIG. 5, example test results 500 of a load test performed by an agent is shown. In particular, an agent may perform a load test (as shown, TestID: 7890) that is configured to test a variety of parameters for a visit by the agent to a particular web application, which is shown as “Domain A” in FIG. 5. Such parameters may include throughput and response time, which are indicated by corresponding throughput pane 502 and total response time pane 504. Throughput pane 502 includes throughputs to Domain A, Domain B, and Domain C, which were all loaded during the visit by the agent to Domain A. Total response time pane 504 includes the response times for each of Domain A, Domain B, and Domain C during the visit by the agent to Domain A.

Test results 500 may also include a waterfall view pane 506, which in addition to displaying each of the domains visited during a loading (e.g., page load) of a visit to Domain A, also displays each of services that may be at sub-levels of domains that were loaded during in temporal order of the agent's visit to Domain A. Notably, waterfall view pane 506 indicates that the agent loaded particular objects/services 508 of Domain A then particular objects/services 510 of Domain B then particular objects/services 512 of Domain C. For each of these services 508-512, waterfall view pane 506 may include a corresponding identifier, file size, and specific response time.

While the test results 500 are shown indicating that various levels of domains are being tracked (e.g., a first level and a second level), it is contemplated that tests performed by the agents may be configured to only higher (or even further lower) levels. In other words, various limitations may be placed herein on the level of domains being tracked, meaning second level domains and third level domains, and so on. In certain embodiments, page load analyzer 404 may implemented such that certain second level domains may be associated with a level of trust, while any deeper (e.g., third level or lower) domains need not be tracked or at least not flagged as anomalies (e.g., where they change so regularly). I

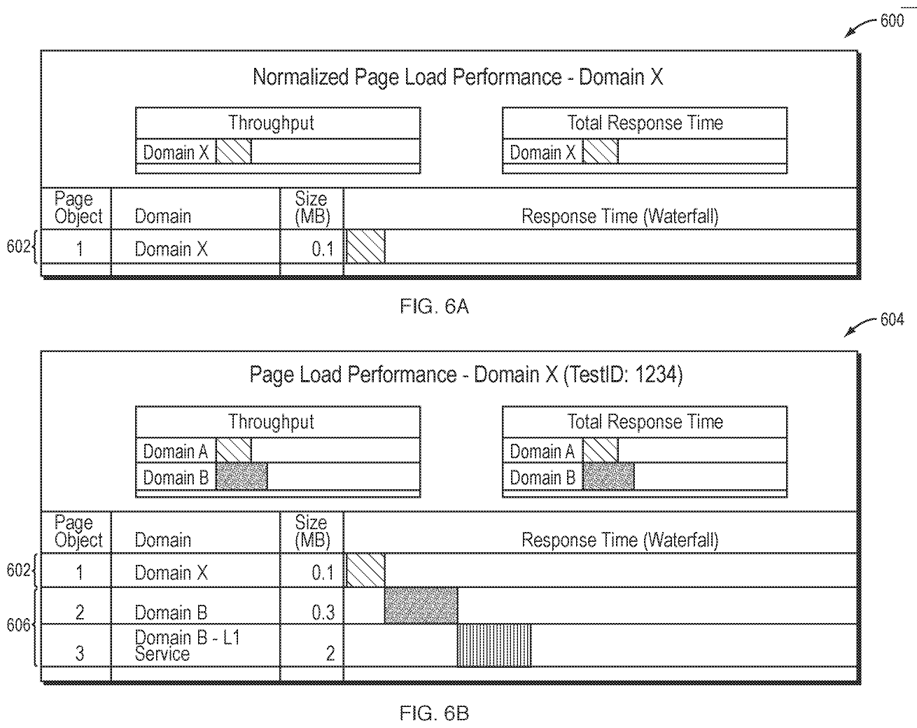

Turning to FIGS. 6A-6B, an example comparison of a normalized loading of a web application with a subsequent loading of the web application is shown. In particular, FIG. 6A shows a normalized baseline of expected domain(s) 600 for a loading of an example simplified web application, comprising only Domain X. Page load test aggregator 402 may have gathered test results from plurality of loadings of Domain X (by agents), and page load analyzer 404 may have normalized the test results to determine that visits to Domain X should typically lead to only loadings of a single page object “1” 602 from Domain X.

FIG. 6B illustrates a subsequent loading 606 of Domain X by, for example, an end-user device with an agent, where the subsequent loading includes loadings of the single page object “1” 602 as well additional page objects “2” and “3” 606 from Domain B. Anomaly detector and notifier 406 may deem additional page objects “2” and “3” from Domain B as anomalous domains and associated data because these page objects were not included in normalized baseline of expected domain(s) 600. It is contemplated that a different agent, performing the same test (e.g., Page Load TestID:1234) may not lead to a loading of the same results in that a geographic location, software, other factors, etc. may have led to it loading different objects (e.g., single page object “1” 602).

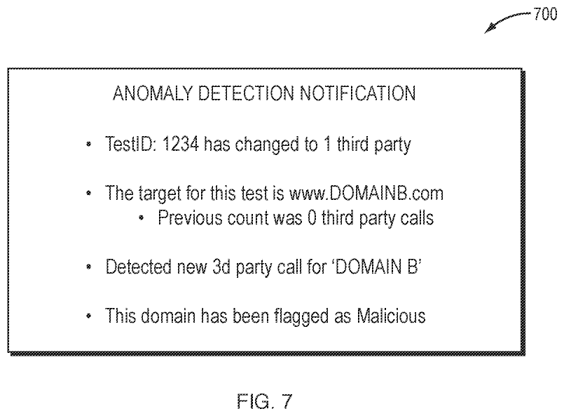

Additionally, anomaly detector and notifier 406 may cause an example anomaly detection notification 700, shown in FIG. 7, to be generated and displayed at an end-user device in response to the detection of the anomalous domain(s). Anomaly detection notification 700 may include an identifier of the particular test that was performed (as shown, TestID: 1234) as well as indications of the nature of the anomalous domains (e.g., the address of the domain, type of loaded object from the domain, and a categorization of the anomalous domain). Additionally, anomaly detection notification 700 may include: a time that a test was ran (e.g., in UTC); an organizational identifier (indicative of who or what entity a test/analysis is being performed for); an account group identifier; or a name of test. Altogether, information included in anomaly detection notification 700 may include information for manual analysis (e.g., by an end user) of an indicated anomaly following an alert (e.g. notification 700) if desired. It is contemplated that this may occur if an alert is due to a cross-application anomaly where multiple customers may be involved.

As described above, the anomaly may be determined by anomaly detector and notifier 406 as “Malicious” in the case that Domain B is placed on a list of known malicious domains. Alternatively, it may have been determined to be malicious due to cross-application analysis module 408 analyzing it as malicious.

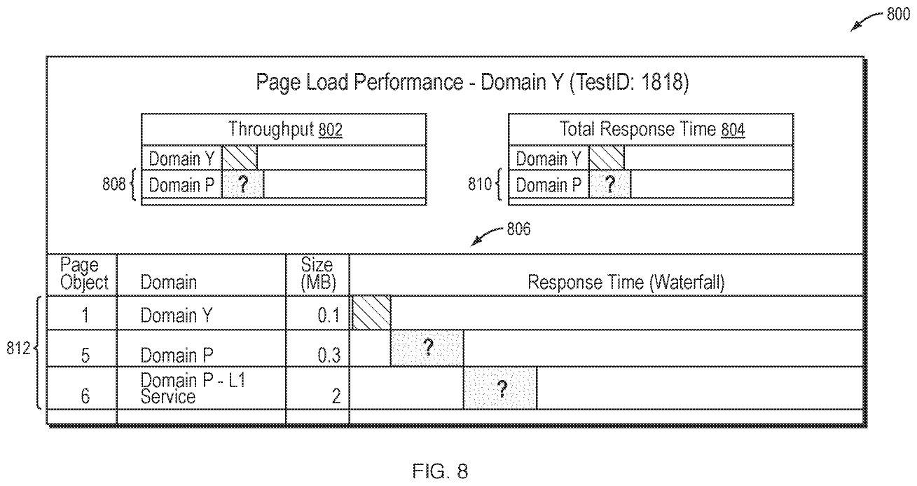

In another embodiment, the techniques described herein may be leveraged for the purposes of change management. With respect to FIG. 8, example page load test results 800 indicative of whether expected changes for web application have occurred is shown. In particular, as described herein above, an operator of a web application, for example, Domain Y, may have modified the web application such that loading of the web application would additionally include objects from Domain P (instead of only Domain Y). One or more agents, located in geographically different regions, may be configured to perform tests as described herein, and the results of these test would indicate whether loading(s) of objects from Domain P do occur. In the case of the change to the web application occurring correctly, a throughput pane 802, a response time pane 804, and a waterfall pane 806 would have indications 808-814 that show that the agents actually loaded objects from Domain P. However, in the case that a content delivery network (CDN) speed is slow, roll-outs are delayed, etc., indications 808-812 may not appear or get fully distributed as expected. Accordingly, the techniques herein may reveal whether there is a geographic limitation (or infrastructure limitation) for how changes to a web application are being implemented.

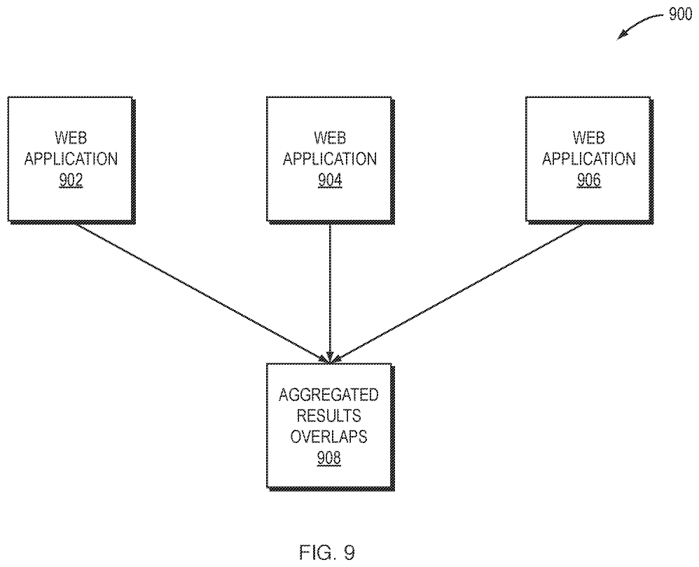

In one or more additional embodiments, as noted above, the techniques herein may also leverage a broader knowledge of page loading across a number of “similar” customers. For instance, turning now to FIG. 9, an example architecture 900 for cross-application page load test monitoring is shown. As described with respect to cross-application analysis module 408 herein above, cross-application analysis module 408 may be configured to receive test results from agents, where the tests may be for a plurality of web applications (or webpages) 902-906. Using the test results, cross-application analysis module 408 may thus be configured to normalize an aggregation of the test results 908, for instance, to determine whether one or more domains are visited/loaded across loadings of the plurality of the web applications, as described above. Note that determining whether certain web applications 902-906 may be classified as “similar” for aggregation in this manner may be based on a number of factors, such as a) overlapping segments of similarly loaded domains (e.g., and only aggregating the overlapping segments of similarly loaded domains), such as for advertisements, embedded services, and so on, b) machine learning based determinations from clustering page load tests, c) manual admin configuration (e.g., “bank” customers or “hotel” customers, etc.), and d) other suitable determination techniques not specifically mentioned herein.

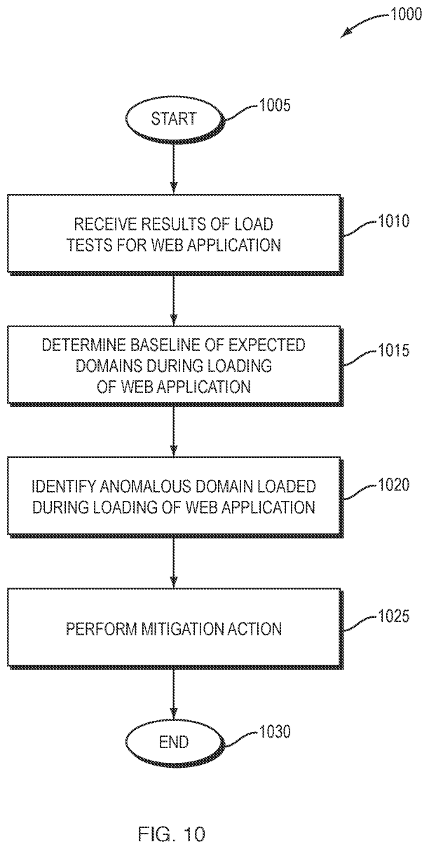

In closing, FIG. 10 illustrates an example simplified procedure for detection and mitigation of domain-based anomalies in accordance with one or more embodiments described herein, particularly from the perspective of either an edge device or a controller. For example, a non-generic, specifically configured device (e.g., device 200, particularly a page load monitoring device) may perform procedure 1000 by executing stored instructions (e.g., process 248, such as a page load monitoring process). The procedure 1000 may start at step 1005, and continues to step 1010, where, as described in greater detail above, a device receives results of a plurality of load tests for a web application, the results comprising information about one or more domains accessed when loading the web application during the plurality of load tests. In an embodiment, one or more agents may perform load tests to generate the results of the plurality of load tests. In another embodiment, the web application may comprise a webpage, and the plurality of load tests may comprise page load tests. In a further embodiment, the plurality of load tests may be performed by agents selected from the group consisting of cloud agents, enterprise agents, and endpoint agents. In a further embodiment, wherein the anomalous domain comprises a particular domain from the baseline of expected domains but data associated with the loading of the particular domain for the web application is anomalous.

At step 1015, the device may determine a baseline of expected domains that are accessed during loading of the web application based on normalizing the results of the plurality of load tests. In an embodiment, the device may determine the baseline of expected domains that are accessed during loading of the web application based on a specific time period of the results of the plurality of load tests. In one particular embodiment, the device may further determine the baseline of expected domains that are accessed during the loading of the web application based on normalizing results of a plurality of load tests for another web application. For example, the device may do so based on web applications that share a common industrial purpose, end users, etc.

At step 1020, the device may identify, based on the baseline of expected domains, an anomalous domain that is loaded during a loading of the web application. (Note that determining “an” anomalous domain herein may further include a plurality of anomalous domains, including insertion of one or more domains, or a complete change in domains (e.g., removing or replacing domains that were otherwise expected to be loaded).) In an embodiment, the device may identify the anomalous domain that is loaded during the loading of the web application by matching the anomalous domain to a domain in a list of known malicious domains.

At step 1025, the device may perform one or more mitigation actions in response to identifying the anomalous domain. In an embodiment, the one or more mitigation actions may comprise blocking the anomalous domain from the loading of the web application. In another embodiment, the one or more mitigation actions may comprise causing a graphical user interface to display an indication of the anomalous domain at an end-user device.

The simplified procedure 1000 may then end in step 1030, notably with the ability to continue ingesting and processing data. Other steps may also be included generally within procedure 1000. For example, such steps (or, more generally, such additions to steps already specifically illustrated above), may include: receiving results of a plurality of multi-step transaction test comprising additional information about the one or more domains; and so on.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, provide for detection and mitigation of domain-based anomalies. In particular, the techniques herein leverage various types of agents and their ability to perform tests, particularly, tests that identify one or more domains that are accessed by agents (e.g., a Page Load test or a Transaction test) while loading a web application (or a webpage). Aggregation and normalization of the tests allows a baseline of “expected” domains, for subsequent loadings of the web application, to be determined. Based on the baseline of “expected” domains, anomalous domains may be identified, and, in response, mitigation action(s) may be performed.

Illustratively, the techniques described herein may be performed by hardware, software, and/or firmware, such as in accordance with the illustrative page load monitoring process 248, which may include computer executable instructions executed by the processor 220 to perform functions relating to the techniques described herein, e.g., in conjunction with corresponding processes of other devices in the computer network as described herein (e.g., on network agents, controllers, computing devices, servers, etc.). In addition, the components herein may be implemented on a singular device or in a distributed manner, in which case the combination of executing devices can be viewed as their own singular “device” for purposes of executing the process 248.

According to the embodiments herein, an illustrative method herein may comprise: receiving, at a device, results of a plurality of load tests for a web application, the results comprising information about one or more domains accessed when loading the web application during the plurality of load tests; determining, by the device, a baseline of expected domains that are accessed during loading of the web application based on normalizing the results of the plurality of load tests; identifying, by the device and based on the baseline of expected domains, an anomalous domain that is loaded during a loading of the web application; and performing, by the device, one or more mitigation actions in response to identifying the anomalous domain.

In one embodiment, one or more agents perform load tests to generate the results of the plurality of load tests. In one embodiment, the method may further comprise: receiving, by the device, results of a plurality of multi-step transaction test comprising additional information about the one or more domains. In one embodiment, identifying, by the device and based on the baseline of expected domains, the anomalous domain that is loaded during the loading of the web application comprises matching the anomalous domain to a domain in a list of known malicious domains. In one embodiment, determining, by the device, the baseline of expected domains that are accessed during loading of the web application is further based on a specific time period of the results of the plurality of load tests. In one embodiment, the web application comprises a webpage, further wherein the plurality of load tests comprises page load tests. In one embodiment, determining, by the device, the baseline of expected domains that are accessed during the loading of the web application is further based on normalizing results of a plurality of load tests for another web application. In one embodiment, the one or more mitigation actions comprises blocking, by the device, the anomalous domain from the loading of the web application. In one embodiment, the one or more mitigation actions comprises causing a graphical user interface to display an indication of the anomalous domain at an end-user device. In one embodiment, the anomalous domain comprises a particular domain from the baseline of expected domains but data associated with the loading of the particular domain for the web application is anomalous.

According to the embodiments herein, an illustrative tangible, non-transitory, computer-readable medium herein may have computer-executable instructions stored thereon that, when executed by a processor on a computer, may cause the computer to perform a method comprising: receiving, at a device, results of a plurality of load tests for a web application, the results comprising information about one or more domains accessed when loading the web application during the plurality of load tests; determining, by the device, a baseline of expected domains that are accessed during loading of the web application based on normalizing the results of the plurality of load tests; identifying, by the device and based on the baseline of expected domains, an anomalous domain that is loaded during a loading of the web application; and performing, by the device, one or more mitigation actions in response to identifying the anomalous domain.

Further, according to the embodiments herein an illustrative apparatus herein may comprise: one or more network interfaces to communicate with a network; a processor coupled to the network interfaces and configured to execute one or more processes; and a memory configured to store a process that is executable by the processor, the process, when executed, configured to: receive results of a plurality of load tests for a web application, the results comprising information about one or more domains accessed when loading the web application during the plurality of load tests; determine a baseline of expected domains that are accessed during loading of the web application based on normalizing the results of the plurality of load tests; identify, based on the baseline of expected domains, an anomalous domain that is loaded during a loading of the web application; and perform one or more mitigation actions in response to identifying the anomalous domain.

While there have been shown and described illustrative embodiments above, it is to be understood that various other adaptations and modifications may be made within the scope of the embodiments herein. For example, while certain embodiments are described herein with respect to certain types of networks in particular, the techniques are not limited as such and may be used with any computer network, generally, in other embodiments. Moreover, while specific technologies, protocols, and associated devices have been shown, such as Java, TCP, IP, and so on, other suitable technologies, protocols, and associated devices may be used in accordance with the techniques described above. In addition, while certain devices are shown, and with certain functionality being performed on certain devices, other suitable devices and process locations may be used, accordingly. That is, the embodiments have been shown and described herein with relation to specific network configurations (orientations, topologies, protocols, terminology, processing locations, etc.). However, the embodiments in their broader sense are not as limited, and may, in fact, be used with other types of networks, protocols, and configurations.

Also, while the techniques herein have been described regarding identification of anomalous domains, the concepts herein may also apply to identification and mitigation of anomalous data as well. In other words, the techniques herein may be configured to ascertain data that is loaded during load tests of a web application and to normalize the data across time and/or agents. Subsequent loadings of web application may be analyzed to determine whether the subsequent loadings are “normal” or include anomalous data. In such example, then, it is contemplated that a domain being identified as anomalous, may, in fact, be based on the data associated with the domain being identified as anomalous. That is, an anomalous domain may comprise a particular domain from the baseline of expected domains, but data associated with the loading of the particular domain for the web application is anomalous.

Moreover, while the present disclosure contains many other specifics, these should not be construed as limitations on the scope of any embodiment or of what may be claimed, but rather as descriptions of features that may be specific to particular embodiments of particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

For instance, while certain aspects of the present disclosure are described in terms of being performed “by a server” or “by a controller” or “by a collection engine”, those skilled in the art will appreciate that agents of the observability intelligence platform (e.g., application agents, network agents, language agents, etc.) may be considered to be extensions of the server (or controller/engine) operation, and as such, any process step performed “by a server” need not be limited to local processing on a specific server device, unless otherwise specifically noted as such. Furthermore, while certain aspects are described as being performed “by an agent” or by particular types of agents (e.g., application agents, network agents, endpoint agents, enterprise agents, cloud agents, etc.), the techniques may be generally applied to any suitable software/hardware configuration (libraries, modules, etc.) as part of an apparatus, application, or otherwise.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in the present disclosure should not be understood as requiring such separation in all embodiments.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method, comprising:
receiving, at a device, results of a plurality of load tests for a web application, the results comprising information about one or more domains accessed when loading the web application during the plurality of load tests;
determining, by the device, a baseline of expected domains that are accessed during loading of the web application based on normalizing the results of the plurality of load tests;
identifying, by the device and based on the baseline of expected domains, an anomalous domain that is loaded during a loading of the web application; and
performing, by the device, one or more mitigation actions in response to identifying the anomalous domain.

2. The method as in claim 1, wherein one or more agents perform load tests to generate the results of the plurality of load tests.

3. The method as in claim 1, further comprising:
receiving, by the device, results of a plurality of multi-step transaction test comprising additional information about the one or more domains.

4. The method as in claim 1, wherein identifying, by the device and based on the baseline of expected domains, the anomalous domain that is loaded during the loading of the web application comprises matching the anomalous domain to a domain in a list of known malicious domains.

5. The method as in claim 1, wherein determining, by the device, the baseline of expected domains that are accessed during loading of the web application is further based on a specific time period of the results of the plurality of load tests.

6. The method as in claim 1, wherein the web application comprises a webpage, further wherein the results of the plurality of load tests comprises results of page load tests.

7. The method as in claim 1 wherein determining, by the device, the baseline of expected domains that are accessed during the loading of the web application is further based on normalizing results of a plurality of load tests for another web application.

8. The method as in claim 1, wherein the one or more mitigation actions comprises blocking, by the device, the anomalous domain from the loading of the web application.

9. The method as in claim 1, wherein the one or more mitigation actions comprises causing a graphical user interface to display an indication of the anomalous domain at an end-user device.

10. The method as in claim 1, wherein the anomalous domain comprises a particular domain from the baseline of expected domains but data associated with the loading of the particular domain for the web application is anomalous.

11. A tangible, non-transitory, computer-readable medium having computer-executable instructions stored thereon that, when executed by a processor on a computer, cause the computer to perform a method comprising:
receiving results of a plurality of load tests for a web application, the results comprising information about one or more domains accessed when loading the web application during the plurality of load tests;
determining a baseline of expected domains that are accessed during loading of the web application based on normalizing the results of the plurality of load tests;
identifying, based on the baseline of expected domains, an anomalous domain that is loaded during a loading of the web application; and
performing one or more mitigation actions in response to identifying the anomalous domain.

12. The tangible, non-transitory, computer-readable medium as in claim 11, wherein one or more agents perform load tests to generate the results of the plurality of load tests.

13. The tangible, non-transitory, computer-readable medium as in claim 11, wherein the method further comprises:
receiving results of a plurality of multi-step transaction test comprising additional information about the one or more domains.

14. The tangible, non-transitory, computer-readable medium as in claim 11, wherein identifying, based on the baseline of expected domains, the anomalous domain that is loaded during the loading of the web application comprises matching the anomalous domain to a domain in a list of known malicious domains.

15. The tangible, non-transitory, computer-readable medium as in claim 11, wherein determining the baseline of expected domains that are accessed during loading of the web application is further based on a specific time period of the results of the plurality of load tests.

16. The tangible, non-transitory, computer-readable medium as in claim 11, wherein the web application comprises a webpage, further wherein the plurality of load tests comprises page load tests.

17. The tangible, non-transitory, computer-readable medium as in claim 11, wherein determining the baseline of expected domains that are accessed during the loading of the web application is further based on normalizing results of a plurality of load tests for another web application.

18. The tangible, non-transitory, computer-readable medium as in claim 11, wherein the one or more mitigation actions comprises blocking the anomalous domain from the loading of the web application.

19. The tangible, non-transitory, computer-readable medium as in claim 11, wherein the one or more mitigation actions comprises causing a graphical user interface to display an indication of the anomalous domain at an end-user device.

20. An apparatus, comprising:
one or more network interfaces to communicate with a network;
a processor coupled to the one or more network interfaces and configured to execute one or more processes; and
a memory configured to store a process that is executable by the processor, the process, when executed, configured to:
receive results of a plurality of load tests for a web application, the results comprising information about one or more domains accessed when loading the web application during the plurality of load tests;
determine a baseline of expected domains that are accessed during loading of the web application based on normalizing the results of the plurality of load tests;
identify, based on the baseline of expected domains, an anomalous domain that is loaded during a loading of the web application; and
perform one or more mitigation actions in response to identifying the anomalous domain.
